(19) United States
(12) Patent Application Publication
(10) Pub. No.: US 2013/0027463 A1
(43) Pub. Date: Jan. 31, 2013

(54) INK CARTRIDGE AND INK JET RECORDING METHOD

(71) Applicants: Masashi Ogasawara, Machida-shi (JP); Keigo Gouda, Kawasaki-shi (JP); Fumiaki Fujioka, Kawasaki-shi (JP); Souichi Nagai, Kawasaki-shi (JP); Akiko Yasuda, Kawasaki-shi (JP); Keiichiro Tsukuda, Yokohama-shi (JP); Hiromasa Amma, Kawasaki-shi (JP); Kyosuke Toda, Kawasaki-shi (JP)

(72) Inventors: Masashi Ogasawara, Machida-shi (JP); Keigo Gouda, Kawasaki-shi (JP); Fumiaki Fujioka, Kawasaki-shi (JP); Souichi Nagai, Kawasaki-shi (JP); Akiko Yasuda, Kawasaki-shi (JP); Keiichiro Tsukuda, Yokohama-shi (JP); Hiromasa Amma, Kawasaki-shi (JP); Kyosuke Toda, Kawasaki-shi (JP)

(73) Assignee: CANON KABUSHIKI KAISHA, Tokyo (JP)

(21) Appl. No.: 13/526,826

(22) Filed: Jun. 19, 2012

(30) Foreign Application Priority Data
Jul. 27, 2011 (JP) 2011-163790

(51) Int. Cl. B41J 2/175

(52) U.S. Cl. 347/20; 347/86

(57) ABSTRACT

An ink cartridge including a housing formed with a resin and an ink stored in the housing, wherein the resin includes a white mica composition; the ink includes a salt and a self-dispersible pigment having a functional group that contains two phosphonic acid groups and is bonded to the particle surface thereof; the salt includes a specific cation and a specific anion; and an amount of calcium in the ink after the ink is preserved in the housing at 60° C. for 2 months is 10.0 ppm or less.

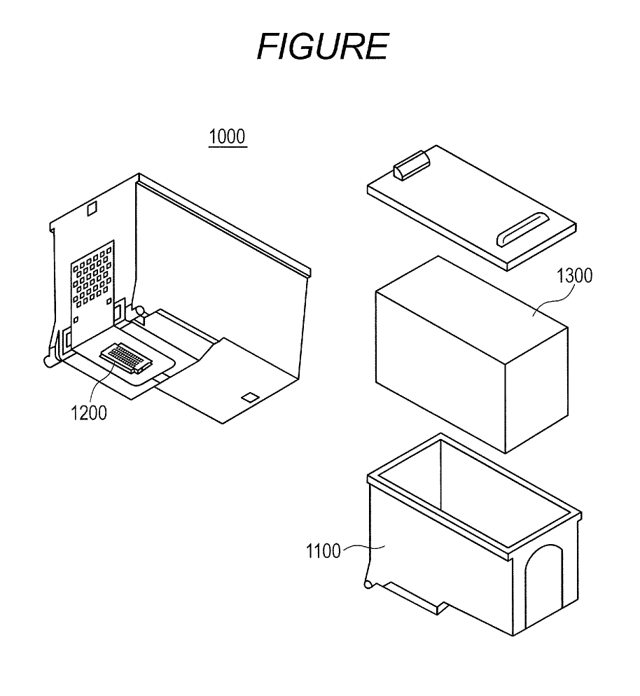

### BACKGROUND OF THE INVENTION

1. Field of the Invention

The present invention relates to an ink cartridge and an ink jet recording method using the ink cartridge.

2. Description of the Related Art

Ink jet recording apparatus uses an ink cartridge having a function to supply an ink stored therein to a recording head. Examples of the ink cartridge include those having a configuration in which a compressed porous body such as a sponge as an ink absorber is held in a container (housing) obtained by molding a thermoplastic resin by injection molding or the like, and the ink absorber holds an ink. Recently, particularly high dimensional accuracy and strength have been demanded of the ink cartridge. To meet such a demand, for example, a filler is blended with a resin that is a material forming a housing of the ink cartridge.

Meanwhile, as a black ink used for the ink jet recording method, an ink capable of giving an image having high optical density and fastness and using a pigment as a coloring material has been investigated. For example, Japanese Patent Application Laid-Open No. 2000-198955 discloses use of an ink containing a self-dispersible carbon black and a specific salt, by which an image having high optical density and a high quality of characters is obtained. Moreover, Japanese Patent Application Laid-Open No. 2009-515007 proposes that a self-dispersible pigment is used in which a functional group highly reactive with calcium is selected based on a calcium index value specifying an index of a reactivity with calcium; thereby, the optical density can be improved.

### SUMMARY OF THE INVENTION

As described above, it is conventionally understood that use of the ink containing a self-dispersible pigment and a salt can enhances the optical density of an image to be recorded. The investigation by the present inventors discovered, however, that the optical density of the image to be recorded is still insufficient in the case where a highly permeable recording medium is used. It has been also found out that if the ink stored in the ink cartridge is preserved for a long period of time, some kinds of ink may produce a precipitate attributed to the component dissolved from the housing.

The present invention has been made in consideration of such problems in the related art. Namely, an object of the present invention is to provide an ink cartridge that enables long-term preservation of an ink that enables recording of an image having high optical density irrespective of the kind of a recording medium, has high dimensional accuracy, and endures a drop impact. Another object of the present invention is to provide an ink jet recording method that enables stable recording of an image having high optical density irrespective of the kind of a recording medium.

Namely, the present invention provides an ink cartridge including a housing formed with a resin and an ink stored in the housing, wherein the resin includes a white mica composition; the ink includes a salt and a self-dispersible pigment having a functional group that contains two phosphonic acid groups and is bonded to a particle surface thereof; the salt includes at least one cation selected from the group consisting of an alkali metal ion, an ammonium ion and an organic ammonium ion and at least one anion selected from the group consisting of Cl⁻, Br⁻, I⁻, ClO⁻, ClO₂⁻, ClO₃⁻, ClO₄⁻, NO₂⁻, NO₃⁻, SO₄²⁻, CO₃²⁻, HCO₃⁻, HCOO⁻, (COO⁻)₂, COOH(COO⁻), CH₃COO⁻, C₂H₄(COO⁻)₂, C₆H₅COO⁻, C₆H₄(COO⁻)₂, PO₄³⁻, HPO₄²⁻ and H₂PO₄⁻; and an amount of calcium in the ink after the ink is preserved in the housing at 60° C. for 2 months is 10.0 ppm or less.

The ink cartridge according to the present invention can preserve an ink capable of recording an image having high optical density irrespective of the kind of a recording medium for a long period of time. For this, the ink stored in the ink cartridge according to the present invention sufficiently demonstrates high performance even after long-term preservation. The ink cartridge according to the present invention has high dimensional accuracy and can endure a drop impact. For this, if the ink cartridge is dropped by mistake, the ink cartridge can be used without any problem. According to the ink jet recording method according to the present invention, an image having high optical density can be stably recorded irrespective of the kind of a recording medium.

Further features of the present invention will become apparent from the following description of exemplary embodiments with reference to the attached drawing.

### BRIEF DESCRIPTION OF THE DRAWINGS

FIGURE is an exploded perspective view illustrating one embodiment of an ink cartridge according to the present invention.

### DESCRIPTION OF THE EMBODIMENTS

Preferred embodiments of the present invention will now be described in detail in accordance with the accompanying drawings.

Hereinafter, the present invention will be described in detail using a preferred embodiment of the present invention. Hereinafter, two phosphonic acid groups may be referred to as a “bisphosphonic acid group,” and a self-dispersible pigment having a functional group that contains two phosphonic acid groups and is bonded to a particle surface thereof may be referred to as a “bisphosphonic acid type self-dispersible pigment.” In the present invention, values of a variety of physical properties are values at 25° C., unless otherwise specified.

Usually, the dispersion state of the self-dispersible pigment in the ink applied to a recording medium becomes unstable with vaporization of moisture and change in the component ratio of the ink associated therewith, and with permeation of a liquid component into the recording medium. As a result, the self-dispersible pigment aggregates. The present inventors found out that using a specific combination of the structure of the functional group bonded to the surface of the pigment particle with a salt contained in the ink, the optical density of the image to be recorded is significantly improved compared to the conventional ink containing a carboxylic acid type self-dispersible pigment and a salt. Specifically, a bisphosphonic acid type self-dispersible pigment and a specific salt are used in combination to improve the optical density of the image to be recorded remarkably compared to the conventional ink containing a carboxylic acid type self-dispersible pigment.

The present inventors presume the mechanism that provides the effect as above as follows. The bisphosphonic acid type self-dispersible pigment reacts with calcium contained in the recording medium as a filler more strongly than the sulfonic acid type and carboxylic acid type self-dispersible pigments or the self-dispersible pigment having a functional group that contains one phosphonic acid group and is bonded to the particle surface thereof. For this, use of the ink containing the bisphosphonic acid type self-dispersible pigment enables recording of an image having particularly high optical density.

That such an effect is obtained is supported by the fact that a divalent acid has a reactivity with calcium higher than that of a monovalent acid. For example, biscarboxylic acid, which is a divalent acid, has reactivity with calcium higher than that of monocarboxylic acid of a monovalent acid. Namely, focusing on the solubility at 20° C. of a calcium salt, which is a guideline for measuring the reactivity with calcium, there is a difference between the monocarboxylic acid and the biscarboxylic acid as follows. The solubility at 20° C. of calcium acetate as a monocarboxylic acid is 40 g/100 mL of water. Meanwhile, the solubility at 20° C. of calcium oxalate as a biscarboxylic acid is 6.7×10⁻⁴ g/100 mL of water. Namely, in comparison of the solubility per 1 mol of carboxylic acid, the solubility of the divalent acid is lower than that of the monovalent acid.

From these facts about carboxylic acid, it is expected that a calcium salt of bisphosphonic acid that is a divalent acid has solubility lower than that of a calcium salt of monophosphonic acid, which is a monovalent acid. Actually, it can be said that bisphosphonic acid has a reactivity with calcium higher than that of monophosphonic acid. This can also be verified by comparing the calcium index described in Japanese Patent Application Laid-Open No. 2009-515007.

According to the investigation by the present inventors, it was found that an influence of permeability of the ink into the recording medium is dominant in the case where an ink containing a bisphosphonic acid type self-dispersible pigment but containing no salt is used to record an image on a highly permeable recording medium. Namely, it was found out that the pigment does not remain in the vicinity of the surface of the recording medium, but permeates in the thickness direction of the recording medium; for this, the optical density of the image to be recorded is not improved much. Contrary to this, in the present invention, a specific salt is contained in the ink together with the bisphosphonic acid type self-dispersible pigment to make the dispersion state of the pigment in the ink unstable to some extent. Thereby, the optical density of the image to be recorded can be efficiently improved. Namely, when the ink used in the present invention is applied to the recording medium, the ink quickly reacts with calcium contained in the recording medium. Thereby, even if an image is recorded on a highly permeable recording medium, a large amount of the pigment can be left in the vicinity of the surface of the recording medium to improve the optical density of the image to be recorded.

Meanwhile, according to the investigation by the present inventors, it was found out that if the ink containing the bisphosphonic acid type self-dispersible pigment is stored in an ink cartridge whose housing is formed with a resin containing a specific material, the following problem occurs. Namely, calcium is dissolved from the housing into the ink, and the dissolved calcium may cause aggregation of the pigment. Particularly, in the case where the ink contains a salt, aggregation of the pigment is more remarkable.

Generally, in the case where an ink stored in an ink cartridge is preserved for a long period of time, the pigment in the ink is likely to be sedimented in the direction of the bottom of the ink cartridge (gravity direction). Accordingly, the concentration of the pigment has a gradient in the ink storage portion to produce a region in the vicinity of the bottom of the ink cartridge in which a relatively large amount of the pigment is present. Even if such a sedimentation phenomenon of the pigment occurs, it can be said that in general no ejection properties or image quality is influenced only by the phenomenon.

Unfortunately, as described above, calcium has high reactivity with the two phosphonic acid groups, and the calcium dissolved from the housing of the ink cartridge reacts with part of the bisphosphonic acid groups of the self-dispersible pigment to form a calcium salt form. The bisphosphonic acid group of a calcium salt form has no function to disperse the pigment. For this, it is thought that the bisphosphonic acid group having the function to disperse the pigment is relatively decreased to reduce electrostatic repulsion action between pigment particles. The electrostatic repulsion action between the pigment particles is remarkably larger in the bisphosphonic acid type self-dispersible pigment than in the carboxylic acid type self-dispersible pigment. Further, in the case where the ink contains a salt, the electrical double layer of the pigment is more likely to be compressed. Accordingly, it is thought that the electrostatic repulsion action between the pigment particles is likely to be reduced. If the ink is preserved in such a state for a long period of time, the aggregated pigment is likely to be accumulated on the bottom of the ink cartridge also because a large amount of the pigment present in the vicinity of the bottom thereof by the sedimentation phenomenon. If the pigment aggregates in the ink storage portion in this way, the pigment in the ink is decreased to decrease the pigment to be used for recording. As a result, the optical density of the image to be recorded is reduced. Further, the aggregated pigment may prevent a flow of the ink in the ink cartridge, or cause clogging in an ink passage of a recording head.

The housing of the ink cartridge is formed with a resin, and more suitably a thermoplastic resin, as a principal component, and the resin contains a filler blended in order to improve dimensional accuracy, rigidity, and impact strength. Examples of the thermoplastic resins can include polyesters, polycarbonates, polypropylenes, polyethylenes, polystyrenes, polyphenylene ethers, and a mixture thereof and a modified product thereof. As the filler, flake-shaped fillers or fibrous fillers are commonly used. Among the flake-shaped fillers, mica provides better properties in the flexural modulus, the bending strength, and the molding shrinkage rate than those in flake-shaped glass or talc. Accordingly, mica is preferred as the filler for the resin that forms the housing. As the fibrous filler, glass fiber is commonly used. If the fibrous filler and the flake-shaped filler are used in combination as the filler, the dimensional accuracy, the rigidity and the impact strength can be improved particularly in a good balance.

Generally, those generally called “mica” include substances having a variety of chemical compositions and is mineralogically classified into 6 to 7 kinds according to the components. Those used for the material that forms a member required of electrical insulation such as an ink cartridge are “white mica (muscovite)” and “gold mica (phlogopite)” represented by the following compositional formulas:

white mica (muscovite): KAl₂(AlSi₃)O₁₀(OH)₂

gold mica (phlogopite): KMg₃(AlSi₃)(OH)₂

As described above, either of the micas contains no calcium in the compositional formula. However, according to the element analysis by measurement using a fluorescent X-ray analyzer, calcium is detected in the gold mica composition. The reason is presumed to be that the gold mica composition is collected from limestone; therefore, calcium originated from limestone is mixed with the usually available gold mica composition. The present inventors produced a pellet including a polyphenylene ether/polystyrene resin containing 20% by mass of a white mica composition and a pellet including a polyphenylene ether/polystyrene resin containing 20% by mass of a gold mica composition and checked liquid contact properties thereof to the ink. As a result, it turned out that the amount of calcium to be dissolved into the ink is 1 ppm or less in the case of using the pellet containing the white mica composition, while the amount of calcium to be dissolved into the ink is 20 to 30 ppm in the case of using the pellet including the gold mica composition. From the results above, a knowledge was obtained that use of the white mica composition is necessary as the filler for the resin that forms the housing in order to keep preferred mechanical properties as the housing of the ink cartridge and fundamentally suppress elution of calcium.

Meanwhile, glass fiber is usually a material called E glass (alkali-free glass) cut into a predetermined length (chopped strand). The E glass contains calcium as the component. Then, the present inventors prepared a pellet including a polyphenylene ether/polystyrene resin containing 20% by mass of glass fiber, and checked liquid contact properties thereof to the ink. As a result, it turned out that the amount of calcium to be dissolved into the ink is 1 to 3 ppm. Namely, the amount of calcium to be dissolved from the pellet containing glass fiber is considerably smaller than that to be dissolved from the pellet containing the gold mica composition. For this, an influence on the reliability of the ink cartridge given by glass fiber is considerably smaller than that given by the gold mica composition.

From the above, the resin that forms the housing of the ink cartridge according to the present invention needs to contain the white mica composition as the filler. Moreover, the resin may further contain glass fiber. To prevent the thus-configured ink from reducing the optical density of the image to be recorded, the amount of the filler to be blended needs to be controlled such that the amount of calcium to be contained in the ink, which is attributed to calcium to be dissolved from the housing, is of a constant level or less.

The present inventors investigated the threshold of an allowable amount of calcium present in the ink containing the bisphosphonic acid type self-dispersible pigment and a specific salt, and obtained the knowledge below. Namely, in the case where the ink cartridge having the ink stored in the housing is preserved at 60° C. for 2 months, the ink needs to satisfy the condition that the amount of calcium in the ink is 10.0 ppm or less. The condition of preservation at 60° C. for 2 months means an accelerated aging test during a period corresponding to a period in which the ink cartridge is produced and distributed, and the ink stored in the ink cartridge is consumed. It is a condition in which the test period is sufficiently longer than the actually expected period. If the amount of calcium in the ink is controlled at a low level, the performance of the ink containing the bisphosphonic acid type self-dispersible pigment and the specific salt can be kept even after the accelerated aging test to attain high optical density. The ink may contain a slight amount of calcium derived from the constituent material. Accordingly, the threshold of “10.0 ppm” in the present invention designates a value including the slight amount of calcium originally contained in the ink itself.

Generally, the ink cartridge is wrapped in a plastic package and sold. When the package is opened, the ink cartridge is in the same state as that when the ink cartridge is produced. Accordingly, in Examples described later, the accelerated aging test is performed after the ink cartridge is produced.

<Ink>

The ink contains a self-dispersible pigment and a specific salt. Hereinafter, the components that form the ink and physical properties of the ink will be described.

Self-Dispersible Pigment

The self-dispersible pigment contains pigment particles and a specific functional group bonded to the surfaces thereof. Examples of the pigments can include organic pigments and inorganic pigments such as carbon black. Among these, a preferred pigment is carbon black. In the present invention, a black ink using carbon black as the pigment is particularly preferred. The content (% by mass) of the pigment in the ink is preferably 0.1% by mass or more and 15.0% by mass or less, and more preferably 1.0% by mass or more and 10.0% by mass or less, based on the total mass of the ink. A dye may be used in combination with the pigment for color toning or the like.

The self-dispersible pigment needs to be a bisphosphonic acid type self-dispersible pigment in which a functional group containing two phosphonic acid groups is bonded to the surface of the pigment particle. Use of the self-dispersible pigment can eliminate addition of a dispersant for dispersing the pigment in the ink, or reduce the amount of the dispersant to be added.

For example, suppose that an ink including a “monophosphonic acid type self-dispersible pigment” is used, the monophosphonic acid type self-dispersible pigment having a functional group that contains one phosphonic acid group and is bonded to the surface of the particle. Use of such an ink can improve the optical density of the image to be recorded to some extent compared to the case of using an ink including a self-dispersible pigment having a functional group that contains a carboxylic acid group and is bonded to the surface of the particle. Unfortunately, it cannot be always said that improvement in the optical density is sufficient. Moreover, it cannot be said that an ink including a “trisphosphonic acid type self-dispersible pigment” having a functional group that contains three phosphonic acid groups and is bonded to the surface of the particle has sufficient storage stability. Contrary to this, if the ink including a “bisphosphonic acid type self-dispersible pigment” having a functional group that contains two phosphonic acid groups and is bonded to the surface of the particle is used, an image having high optical density can be recorded irrespective of the kind of a recording medium. The ink including such a “bisphosphonic acid type self-dispersible pigment” has high storage stability.

Each of the two phosphonic acid groups contained in the functional group is specifically represented by the formula: —PO(O[M₁])₂. Here, M₁ in the formula each independently represents at least one selected from the group consisting of a hydrogen atom, alkali metals, ammonium and organic ammonium. The phosphonic acid group may be partially dissociated, or totally dissociated.

Namely, the phosphonic acid group can be one of —PO₃H₂ (acid form), —PO₃H⁻M₁⁺ (monobasic salt) and —PO₃²⁻ (M₁⁺)₂ (dibasic salt). The counter ion represented by M₁⁺ is preferably at least one of K⁺ and NH₄⁺ from the viewpoint of keeping the dissociated state of the phosphonic acid group in the ink. In the case where one of the counter ions represented by M₁⁺ is one of K⁺ and NH₄⁺, the other counter ion represented by M₁⁺ may be H⁺.

Preferably, the phosphonic acid group is present in the terminal of the functional group. Namely, another atomic group is preferably present between the surface of the pigment particle and the phosphonic acid group. Specific examples of the atomic group (—R—) can include a linear or branched alkylene group having 1 to 12 carbon atoms, an arylene group such as a phenylene group and a naphthylene group, an amide group, a sulfonyl group, an amino group, a carbonyl group, an ester group and an ether group. A group in combination thereof may be used. Further, the atomic group preferably contains at least one of an alkylene group and an arylene group and contains a group having a hydrogen bonding property (at least one selected from the group consisting of an amide group, a sulfonyl group, an amino group, a carbonyl group, an ester group and an ether group). Particularly, the functional group preferably contains —C₆H₄—CONH— (benzamide structure).

In the case where the phosphonic acid group is bonded via another atomic group to the surface of the pigment particle, more preferably, the functional group further contains a structure of —CQ(PO₃[M₁]₂)₂. Here, Q in the formula represents R, OR, SR, or NR₂ (R each independently represents a hydrogen atom, an alkyl group, an acyl group, an aralkyl group, or an aryl group). In the case where R is a group containing a carbon atom, the number of carbon atoms is preferably 1 to 18. Specific examples of the group containing a carbon atom can include an alkyl group such as a methyl group and an ethyl group; an acyl group such as an acetyl group and a benzoyl group; an aralkyl group such as a benzyl group; and an aryl group such as a phenyl group and a naphthyl group. M₁ in the formula each independently represents at least one selected from the group consisting of a hydrogen atom, alkali metals, ammonium and organic ammonium. Among these, particularly preferably, the structure of —CH(PO₃[M₁]₂)₂ wherein Q is a hydrogen atom is contained in the functional group. In the present invention, the structure of the functional group is particularly preferably —C₆H₄—CONH—CH—(PO₃[M₁]₂)₂.

Introduced Amount of Functional Group

The bisphosphonic acid type self-dispersible pigment very strongly reacts with calcium. Accordingly, the introduced amount of the functional group bonded to the self-dispersible pigment (hereinafter, also referred to as “functional group introduced amount”) hardly influences the optical density of the image to be recorded, compared to the cases of the conventional sulfonic acid type and carboxylic acid type self-dispersible pigments. Meanwhile, the optical density of an image to be recorded by the ink is influenced by the content of the salt in the ink, namely, the concentration of an electrolyte. As the concentration of the electrolyte is higher, the optical density tends to be higher. The bisphosphonic acid type self-dispersible pigment, however, is sensitive to a cation in the ink. As the concentration of the cation is higher, the dispersion state of the pigment is likely to rapidly become unstable by vaporization of moisture in the ink. Accordingly, in order to sufficiently add a salt to the ink to obtain higher optical density, the amount of the cation derived from the functional group is preferably reduced as much as possible. Consequently, the functional group introduced amount is preferably smaller. Specifically, the introduced amount of the functional group into the self-dispersible pigment is preferably 0.38 mmol/g or less. An excessively small functional group introduced amount may weaken the electrostatic repulsion action to disperse the pigment, leading to slight reduction in the storage stability of the ink. For this reason, the introduced amount of the functional group into the self-dispersible pigment is preferably 0.10 mmol/g or more. The “functional group introduced amount” is an amount of the functional group per gram of the pigment solid content (mmol).

In the process of long-term preservation of the ink, from the viewpoint of an influence of calcium that is dissolved from the housing and present in the ink, a larger functional group introduced amount allows a larger amount of calcium to coexist, and a smaller functional group introduced amount allows a smaller amount of calcium to coexist. As described above, however, if the amount of calcium in the ink after the ink is preserved in the housing on the predetermined condition (at 60° C. for 2 months) is controlled at 10.0 ppm or less, the performance of the ink can be maintained.

The introduced amount of functional group bonded to the self-dispersible pigment can be measured by determining the amount of phosphorus as shown below. Specifically, first, a pigment dispersion liquid is diluted with pure water such that the content of the pigment (solid content) is about 0.03% by mass, to prepare a liquid A. The pigment dispersion liquid is subjected to ultracentrifugation on the condition of 5° C., 80,000 rpm, and 15 hours. A supernatant liquid from which the pigment is removed is collected, and diluted with pure water about 80 times to prepare a liquid B. In the obtained liquid A and liquid B, the amount of phosphorus is determined by an ICP Optical Emission Spectrometer. From the difference between the amount of phosphorus determined by measuring the liquid A and that determined by measuring the liquid B, the amount of the phosphonic acid group can be calculated.

The introduced amount of the functional group into the pigment can be calculated by (amount of the phosphonic acid group)/n (n represents the number of the phosphonic acid group contained in one functional group; n=1 if “mono”, n=2 if “bis”, and n=3 if “tris”). Here, if the number of the phosphonic acid group contained in the functional group is unclear, the structure can be analyzed by NMR or the like to be identified. A method using the pigment dispersion liquid has been described, but the measurement can be performed in the same manner using the ink. The method for measuring the functional group introduced amount is not limited to those above.

Salt Constituted by Combining Cation and Anion

The ink contains a salt constituted by combining a cation and an anion, the cation being ionically bonded to the anion. The cation is at least one selected from the group consisting of alkali metal ions, ammonium ions and organic ammonium ions. Specific examples of the alkali metal ions can include a lithium ion, a sodium ion and a potassium ion. Examples of organic ammonium ions include ions of alkylamines having 1 or more and 3 or less carbon atoms such as methylamine and ethylamine; alkanolamines having 1 or more and 4 or less carbon atoms such as monoethanolamine, diethanolamine and triethanolamine. The anion is at least one selected from the group consisting of Cl⁻, Br⁻, I⁻, ClO⁻, ClO₂⁻, ClO₃⁻, ClO₄⁻, NO₂⁻, NO₃⁻, SO₄²⁻, CO₃²⁻, HCO₃⁻, HCOO⁻, (COO⁻)₂, COOH(COO⁻), CH₃COO⁻, C₂H₄(COO⁻)₂, C₆H₅COO⁻, C₆H₄(COO⁻)₂, PO₄³⁻, HPO₄²⁻ and H₂PO₄⁻. The salt in the ink may be partially dissociated, or totally dissociated.

Preferably, the salt is at least one selected from the group consisting of C₆H₄(COO(Na))₂, C₆H₄(COO(K))₂. C₆H₄(COO(NH₄))₂ and (NH₄)₂SO₄. Among these, more preferred is at least one selected from the group consisting of C₆H₄(COO(K))₂, C₆H₄(COO(NH₄))₂ and (NH₄)₂SO₄.

The salt improves the optical density for the following reason. The concentration of the electrolyte in the ink is increased when moisture vaporizes in application of the ink to the recording medium. Thereby, the electrostatic repulsion force of the self-dispersible pigment is weakened to promote aggregation of the pigment. Accordingly, from the viewpoint of improvement in the optical density, it can be said that the dominant factor is the concentration of the electrolyte in the ink, namely, the amount (mol) of the salt, rather than the kind of the ion that forms the salt.

The ink may contain the salt in the range in which a sufficient effect of the present invention can be obtained. Specifically, the content of the salt in the ink (% by mass) is preferably 0.05% by mass or more and 10.0% by mass or less based on the total mass of the ink. At a content of the salt in the ink more than 10.0% by mass, the ink may have insufficient storage stability. Meanwhile, at a content of the salt in the ink less than 0.05% by mass, a sufficient effect of the present invention may not be obtained.

Aqueous Medium

The ink can contain an aqueous medium that is a mixed solvent of water and a water-soluble organic solvent. The ink used in the present invention is preferably an aqueous ink containing at least water. As water, deionized water is preferably used. The content of the water in the ink (% by mass) is preferably 50.0% by mass or more and 95.0% by mass or less based on the total mass of the ink. The content of the water-soluble organic solvent in the ink (% by mass) is preferably 3.0% by mass or more and 50.0% by mass or less based on the total mass of the ink. As the water-soluble organic solvent, any water-soluble organic solvent usable for the ink for ink jet recording such as alcohols, glycols, glycol ethers, nitrogen-containing compounds can be used. More preferred are water-soluble organic solvents whose vapor pressure at 25° C. is lower than that of water. One of these water-soluble organic solvents can be used alone, or two or more thereof can be used in combination.

Other Additives

Besides the components, the ink may contain solid water-soluble organic compounds at normal temperature such as urea and derivatives thereof, trimethylolpropane and trimethylolethane as additives. The content of the water-soluble organic compound in the ink (% by mass) is preferably 0.1% by mass or more and 20.0% by mass or less, and more preferably 3.0% by mass or more and 10.0% by mass or less, based on the total mass of the ink. When necessary, the ink may contain a variety of additives such as a surfactant, a resin, a pH adjuster, an antifoaming agent, a rust inhibitor, a preservative agent, a fungicide, an antioxidant, a reduction inhibitor and a chelating agent.

Preferably, the ink contains a surfactant such as acetylene-glycol-based surfactants, fluorine-based surfactants, silicone-based surfactants and polyoxyethylene-alkyl-ether-based surfactants. The content of the surfactant in the ink (% by mass) is preferably 0.05% by mass or more and 2.0% by mass or less based on the total mass of the ink.

Physical Properties of Ink

The dynamic surface tension of the ink at 25° C. and a lifetime of 50 milliseconds is preferably 40 mN/m or more, and more preferably 45 mN/m or more. At a dynamic surface tension of the ink within the range of the above numeric values, the pigment can be particularly effectively present on the surface of the recording medium to further enhance the optical density of the image to be recorded. In the present invention, the dynamic surface tension of the ink is measured by a maximum bubble pressure method. In the maximum bubble pressure method, a probe is dipped into a liquid to be measured, and the largest pressure necessary to discharge bubbles from the tip of the probe is measured to determine the surface tension. The “lifetime” means a time period between the time when a bubble is released from the tip of the probe to form a new surface and the time when the pressure thereof reaches the largest bubble pressure in the maximum bubble pressure method. Moreover, “when the pressure thereof reaches the largest bubble pressure” means a time when the curvature radius of the bubble is equal to the radius of the tip of the probe.

Among the above-mentioned surfactants, polyoxyethylene alkyl ether is particularly preferably used to control the dynamic surface tension of the ink in the range of the above numeric values. Further, the HLB value of polyoxyethylene alkyl ether determined by the Griffin method is preferably 13.0 or more and 20.0 or less. An alkyl group in polyoxyethylene alkyl ether preferably has 12 or more and 20 or less carbon atoms. The content of polyoxyethylene alkyl ether in the ink (% by mass) is preferably 0.05% or more by mass and 2.0% by mass or less, and more preferably 0.05% or more by mass and 1.0% by mass or less, based on the total mass of the ink.

<Ink Cartridge>

The ink cartridge according to the present invention includes a housing formed of a resin containing a white mica composition as a filler, and an ink stored in the housing. In a preferred embodiment, a porous body such as a sponge is compressed and held in at least part of the housing as an ink absorber, and the ink absorber holds the ink. Further, the ink cartridge may include a recording head for ejecting ink from an ejection orifice. More preferably, the recording head is a thermal type including a heat generating unit for generating thermal energy.

FIGURE is an exploded perspective view illustrating an embodiment of an ink cartridge according to the present invention. An ink (not illustrated) is filled into a housing 1100 of an ink cartridge 1000. The ink cartridge 1000 is supported by a carriage positioning unit and an electrical contact provided in the main body of an ink jet recording apparatus, and can be detachably mounted on the carriage. When the filled ink is consumed, the ink cartridge 1000 is replaced.

The housing 1100 in the ink cartridge 1000 illustrated in FIGURE has a recording head 1200 integrally formed therewith. The recording head 1200 is a thermal type recording head using an electrothermal converter that generates thermal energy in response to an electric signal to produce film boiling in the ink. The recording head 1200 is the so-called side shooter type in which the electrothermal converter and the ejection orifice are disposed facing each other.

The housing 1100 is mainly formed with a resin material. As the resin, thermoplastic resins that can be molded by injection molding, compression molding, or thermoforming, for example, can be suitably used. Examples of preferred thermoplastic resins include polyesters, polycarbonates, polypropylenes, polyethylenes, polystyrenes, polyphenylene ethers, and a mixture thereof and a modified product thereof. Among these, preferable are polyphenylene ethers, and more preferred is a mixture (polymer alloy) of polyphenylene ether and a styrene-based material.

From the viewpoint of improvement in rigidity and dimensional accuracy, a filler is blended with the resin. The blending amount of the filler can be determined according to the amount of calcium to be contained in the ink and strength of the housing. Specifically, the blending amount of the filler is preferably 5.0% by mass or more and 40.0% by mass or less based on the total mass of the housing (formed with the resin containing the filler). In the present invention, the resin contains a white mica composition as a filler. Preferably, the resin further contains glass fiber as a filler. From the viewpoint of maintaining the performance of the ink, preferably, the kinds and blending amounts of the filler and the resin are determined such that the amount of calcium in the ink after the ink cartridge is preserved at 60° C. for 2 months is 10.0 ppm or less, and the resin is used to form the housing. For this, a gold mica composition may be used as a filler. In this case, the blending amount of the filler needs to be controlled to obtain the above-described amount of calcium. In the present invention, use of a resin containing no gold mica composition is more preferred.

The housing 1100 has a space formed therein, the space storing an ink absorber 1300 for generating negative pressure to hold the ink. The housing 1100 has an ink supplying function to form an independent ink passage for guiding the ink to the ink supplying port of the recording head 1200. The ink absorber 1300 is preferably compressed fiber made of polypropylene or urethane.

<Ink Jet Recording Method>

The ink jet recording method according to the present invention is a method of ejecting an ink stored in an ink cartridge from an ink jet recording head to record an image on a recording medium, wherein the ink cartridge according to the present invention is used. Specific examples of the ink jet system can include a system to give mechanical energy to an ink and a system to give thermal energy to an ink. Among these, particularly preferred is an ink jet method of giving thermal energy to an ink. Known processes of an ink jet recording method may be used except that the ink cartridge according to the present invention is used. Examples of usable recording media can include permeable recording media such as normal paper and gloss paper and non-permeable recording media such as films.

### EXAMPLES

Hereinafter, the present invention will be described more in detail using Examples, Comparative Examples and Reference Examples, but the present invention will not be limited by Examples below unless going beyond the gist thereof. Herein, in the amounts of components, “parts” and “%” are based on the mass unless otherwise specified.

<Preparation of Pigment Dispersion Liquid>

Introduced Amount of Functional Group into Self-Dispersible Pigment

A method for measuring the introduced amount of a functional group in a pigment is first described. A pigment dispersion liquid was diluted with pure water in such a manner that the content of the pigment (solid content) to be measured was about 0.03%, to prepare a liquid A. The pigment dispersion liquid was subjected to ultracentrifugation on the condition of 5° C., 80,000 rpm and hours and a supernatant liquid from which the self-dispersible pigment was removed was collected. The collected supernatant liquid was diluted with pure water about 80 times to prepare a liquid B. In the prepared liquid A and liquid B, the amount of phosphorus was determined using an ICP Optical Emission Spectrometer (trade name “SPS5100,” made by SII Nano Technology Inc.). From the difference between the determined value of phosphorus in the liquid A and the determined value of phosphorus in the liquid B, the amount of the phosphonic acid group was calculated. The calculated amount of the phosphonic acid group was divided by the number of the phosphonic acid group (n) contained in one functional group to calculate the functional group introduced amount (mmol/g).

Pigment Dispersion Liquid 1

20 g of carbon black (solid content), 9 mmol of ((4-aminobenzoylamino)-methane-1,1-diyl)bisphosphonic acid monosodium salt (treatment agent), 20 mmol of nitric acid and 200 mL of pure water were mixed. As the carbon black, trade name “BLACK PEARLS 880”, made by Cabot Corporation was used. The mixing was performed using a Silverson mixer on the condition of room temperature and 6,000 rpm. After mixing for 30 minutes, 20 mmol of sodium nitrite dissolved in a small amount of water was slowly added to the obtained mixture. By addition of sodium nitrite, the temperature of the mixture reached 60° C. The reaction was made in this state for 1 hour. After the reaction, a sodium hydroxide aqueous solution was added to adjust the pH of the mixture to 10. After 30 minutes, 20 mL of pure water was added, and the solution was subjected to diafiltration using a Spectrum membrane. Next, pure water was added such that the content of the pigment was 10.0%.

Thereby, a dispersion liquid was obtained in which a self-dispersible pigment having a —C₆H₄—CONH—CH—(PO(OH)(ONa))(PO(OH)₂) group bonded to the particle surface was dispersed in water. Further, the sodium ion was replaced by an ammonium ion by the ion exchange method. Thereby, Pigment Dispersion Liquid 1 was obtained in which a self-dispersible pigment having a —C₆H₄—CONH—CH—(PO(OH)(ONH₄))(PO(OH)₂) group bonded to the surface of the particle was dispersed in water. The content of the self-dispersible pigment contained in the obtained Pigment Dispersion Liquid 1 was 10.0%. The introduced amount of the functional group into the self-dispersible pigment was 0.33 mmol/g.

Pigment Dispersion Liquid 2

Pigment Dispersion Liquid 2 in which a self-dispersible pigment having a —C₆H₄—CONH—CH—(PO(OH)(ONH₄)) (PO(OH)₂) group bonded to the particle surface was dispersed in water was obtained in the same manner as in the case of Pigment Dispersion Liquid 1 except that the amount of the treatment agent was 14 mmol. The content of the self-dispersible pigment contained in the obtained Pigment Dispersion Liquid 2 was 10.0%. The introduced amount of the functional group into the self-dispersible pigment was 0.46 mmol/g.

Pigment Dispersion Liquid 3

A liquid obtained by dissolving 5 g of concentrated hydrochloric acid in 5.5 g of water was cooled to 5° C. 1.5 g of 4-amino-1,2-benzenedicarboxylic acid (treatment agent, made by Tokyo Chemical Industry Co., Ltd.) was added to the liquid to prepare a solution. A container having the prepared solution was placed in an ice bath. The solution was stirred and the temperature of the solution was kept at a temperature of 10° C. or less. A potassium nitrite aqueous solution at 5° C. obtained by dissolving 1.8 g of potassium nitrite in 9 g of water was added to the solution. After stirring for 15 minutes, 6 g of carbon black (solid content) (trade name “BLACK PEARLS 880,” made by Cabot Corporation) was added under stirring. Subsequently, the solution was further stirred for 15 minutes to obtain a slurry. The obtained slurry was subjected to diafiltration using a Spectrum membrane to obtain particles. The obtained particles were sufficiently washed with water and dried by an oven at 110° C. The potassium ion was replaced by an ammonium ion by the ion exchange method, and pure water was added such that the content of the pigment was 10.0%. Thereby, Pigment Dispersion Liquid 3 was obtained in which a self-dispersible pigment having a —C₆H₃—(COONH₄)₂ group bonded to the particle surface was dispersed in water. The introduced amount of the functional group into the self-dispersible pigment was 0.40 mmol/g. The functional group introduced amount was determined by converting the concentration of the potassium ion in the dispersion liquid before ion exchange, which was measured using an ICP Optical Emission Spectrometer (trade name “SPS5100,” made by SII Nano Technology Inc.).

<Preparation of Inks 1 to 5>

The components (units: %) shown in Table 1 were mixed, sufficiently stirred and filtered under pressured with a polypropylene filter (made by Pall Corporation) having a pore size of 2.5 μm to prepare Inks 1 to 5. “NIKKOL BL-9EX” in Table 1 is polyoxyethylene lauryl ether made by Nikko Chemicals Co., Ltd. The polyoxyethylene lauryl ether is a surfactant of which the HLB value determined by the Griffin method is 13.6 and the number (mol) of the added ethylene oxide group is 9.

TABLE 1
Ink composition

| | Ink | | | | |
|---|---|---|---|---|---|
| | 1 | 2 | 3 | 4 | 5 |
| Pigment dispersion | 30.00 | 30.00 | 30.00 | | |
| liquid 1 | | | | | |
| Pigment dispersion | | | | 30.00 | |
| liquid 2 | | | | | |
| Pigment dispersion | | | | | 30.00 |
| liquid 3 | | | | | |
| Glycerol | 8.00 | 8.00 | 8.00 | 8.00 | 8.00 |
| 2-Pyrrolidone | 5.00 | 5.00 | 5.00 | 5.00 | 5.00 |
| Triethylene glycol | 5.00 | 5.00 | 5.00 | 5.00 | 5.00 |
| Trimethylolpropane | 5.00 | 5.00 | 5.00 | 5.00 | 5.00 |
| NIKKOL BL-9EX | 0.12 | 0.12 | 0.12 | 0.12 | 0.12 |
| Ammonium phthalate | 0.39 | 0.21 | | 0.18 | 0.53 |
| Water | 46.49 | 46.67 | 46.88 | 46.70 | 46.35 |

<Preparation of Housings 1 to 7>

A thermoplastic resin (polymer alloy) which is a mixture of a styrene-based resin and polyphenylene ether and a filler were blended in the proportion (units: parts) shown in the upper columns in Table 2 to obtain a resin. Using each of the obtained resins, housings 1 to 7 having the configuration illustrated in FIGURE were molded. The material for the ink absorber 1300 (see FIGURE) was polypropylene fibers. The fibers were compressed and molded into a sponge form to form an ink absorber. The ink absorber was placed in the housing while the ink absorber was compressed so as to have a volume substantially equal to the inner volume of the housing. The “white mica composition” in Table 2 is a white mica composition made by YAMAGUCHI MICA CO., LTD. (trade name “YM-21S”), and the “gold mica composition” is a gold mica composition made by Repco Inc. (trade name “W-40H”). As the “glass fiber” in Table 2, a chopped strand of an E glass having a length of 5 mm was used. In the lower column in Table 2, the value (units: %) of the blending amount of the filler to the resin that forms the housing is shown.

TABLE 2
Configuration of materials for housing

| | | Housing | | | | | | |
|---|---|---|---|---|---|---|---|---|
| | | 1 | 2 | 3 | 4 | 5 | 6 | 7 |
| Resin | Polymer | 100.0 | 100.0 | 100.0 | 100.0 | 100.0 | 100.0 | 100.0 |
| | alloy | | | | | | | |
| Fillers | White mica | 10.0 | 30.0 | 29.0 | 10.0 | | | |
| | composition | | | | | | | |
| | Gold mica | | | 1.0 | 20.0 | 10.0 | | |
| | composition | | | | | | | |
| | Glass fiber | 25.0 | | | | 25.0 | 30.0 | |

| | | | | | | | |
|---|---|---|---|---|---|---|---|
| Blending amount of | 20.6 | 18.8 | 18.8 | 18.8 | 20.6 | 18.8 | 0.0 |
| filler (%) | | | | | | | |

### Preparation of Ink Cartridge (Examples 1 to 6, Comparative Examples 1 to 6 and Reference Example)

The ink was filled into the housing in the combination shown in Table 3 to produce ink cartridges. The produced ink cartridges were preserved at 60° C. for 2 months in the state where the ink did not vaporize from the ink cartridge. Then, using an ICP Optical Emission Spectrometer (a trade name “SPS5100,” made by SII Nano Technology Inc.), the amount of calcium (ppm) in the ink was measured. The result of measurement is shown in Table 3. Evaluation was made about the following items. The result of evaluation is shown in Table 3. In the criterion of evaluation on the respective items, “AA” and “A” were regarded as an allowable level and “B” and “C” were regarded as an unallowable level.

<Evaluation>

(Optical Density)

An ink cartridge was set in an ink jet recording apparatus including a recording head that ejects an ink by thermal energy (trade name “PIXUS MP480,” made by Canon Inc.). A solid image (2 cm×2 cm/l line) having a recording duty of 100% was recorded on three kinds of recording media (i) to (iii) shown below (plain paper).

(i) trade name “Canon Extra Multifunctional Paper” (made by Canon Inc.)
(ii) trade name “Office Planner” (made by Canon Inc.)
(iii) trade name “Xerox 4024 Premium Multipurpose White Paper” (made by Fuji Xerox Co., Ltd.)

After one day had passed since recording, the optical densities of the solid images recorded on the three kinds of recording media were measured using a reflection densitometer (trade name “Macbeth RD-918,” made by Gretag Macbeth GmbH). Based on the average value of the measured values, the optical density was evaluated. The criterion of evaluation is shown below. The “recording duty=100%” when the ink jet recording apparatus is used is defined as follows. Namely, “recording duty=100%” is defined as a recording duty of the solid image recorded on the condition in which one ink droplet having a mass per one droplet of 25 ng±10% is applied to a unit region of 1/600 inch× 1/600 inch having a resolution of 600 dpi×600 dpi.

AA: the average value is 1.45 or more.
A: the average value is 1.35 or more and less than 1.45.
B: the average value is 1.25 or more and less than 1.35.
C: the average value is less than 1.25.

Reliability of Ink

After the ink cartridge having the ink stored therein was preserved at 80° C. for 2 weeks, presence of a precipitate in the ink was observed to evaluate the reliability of the ink. The criterion of evaluation is shown below.

AA: no precipitate is found.
A: a small amount of precipitates is found.
B: a precipitate is found.
C: a large amount of precipitates is found.

Strength of Housing

The ink cartridge was dropped from a height of 40 cm and observed to evaluate the strength of the housing. The criterion of evaluation is shown below.

AA: no crack is found in the housing.
A: a slight crack is found in the housing, but the housing can be used without any problem.
B: the housing is broken and the ink leaks.

Dimensional Accuracy of Housing

The size of the housing was measured to evaluate the dimensional accuracy of the housing. The criterion of evaluation is shown below.

A: desired size is obtained.
B: desired size is not obtained.

TABLE 3
Configuration of ink cartridge and result of evaluation

| | | | | | Result of evaluation | | | |
|---|---|---|---|---|---|---|---|---|
| | | | | Amount of | | | | Dimensional |
| | | | | calcium | Optical | Reliability | Strength | accuracy of |
| | | Housing | Ink | (ppm) | density | of ink | of housing | housing |
| Example | 1 | 1 | 1 | 3.5 | AA | AA | AA | A |
| | 2 | 2 | 1 | 1.2 | AA | AA | A | A |
| | 3 | 2 | 2 | 1.2 | AA | AA | A | A |
| | 4 | 3 | 1 | 2.2 | AA | AA | A | A |
| | 5 | 1 | 4 | 3.5 | A | AA | AA | A |
| | 6 | 2 | 4 | 1.2 | A | AA | A | A |
| Comparative | 1 | 5 | 1 | 17.1 | AA | C | A | A |
| Example | 2 | 5 | 3 | 17.1 | C | A | AA | A |
| | 3 | 6 | 1 | 3.9 | AA | AA | AA | B |
| | 4 | 5 | 4 | 17.1 | A | B | AA | A |
| | 5 | 4 | 1 | 28.0 | AA | C | A | A |
| | 6 | 7 | 1 | 1.0 | AA | AA | A | B |

| | | | | | | | |
|---|---|---|---|---|---|---|---|
| Reference Example | 5 | 5 | 17.1 | B | AA | AA | A |

Inks using a variety of salts defined in the present invention other than the salts used in Examples above were evaluated in the same manner as in Example 1. Specifically, evaluation was made in the same manner as in Example 1 except that the kind of the salt in the ink in Example 1 was varied, the content of the salt was equimolar to the salt in Example 1, and adjustment was performed with water such that the total amount was 100.00%. As a result, it is determined that these inks are substantially of the rank AA in the item of the optical density although slightly influenced by the number of valence of the salt. The same results of evaluation as those of Example 1 were obtained in the other items for evaluation.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-163790, filed Jul. 27, 2011, which is hereby incorporated by reference herein in its entirety.

What is claimed is:

1. An ink cartridge comprising a housing formed with a resin and an ink stored in the housing, wherein
the resin comprises a white mica composition;
the ink comprises a salt and a self-dispersible pigment having a functional group that contains two phosphonic acid groups and is bonded to a particle surface thereof;
the salt comprises at least one cation selected from the group consisting of an alkali metal ion, an ammonium ion and an organic ammonium ion and at least one anion selected from the group consisting of Cl⁻, Br⁻, I⁻, ClO⁻, ClO₂⁻, ClO₃⁻, ClO₄⁻, NO₂⁻, NO₃⁻, SO₄²⁻, CO₃²⁻, HCO₃⁻, HCOO⁻, (COO⁻)₂, COOH(COO⁻), CH₃COO⁻, C₂H₄(COO⁻)₂, C₆H₅COO⁻, C₆H₄(COO⁻)₂, PO₄³⁻, HPO₄²⁻ and H₂PO₄⁻; and
an amount of calcium in the ink after the ink is preserved in the housing at 60° C. for 2 months is 10.0 ppm or less.

2. The ink cartridge according to claim 1, wherein the resin further comprises a glass fiber.

3. The ink cartridge according to claim 1, wherein an introduced amount of the functional group bonded to the self-dispersible pigment is 0.38 mmol/g or less.

4. An ink jet recording method of ejecting an ink stored in an ink cartridge from an ink jet recording head to record an image on a recording medium, wherein the ink cartridge is the ink cartridge according to claim 1.
